(19) United States
(12) Patent Application Publication
(10) Pub. No.: US 2023/0023357 A1
(43) Pub. Date: Jan. 26, 2023

(54) INTERNAL BALLOON PROJECTOR AND RELATED METHODS

(71) Applicant: Real Simple Ideas, LLC, Orlando, FL (US)

(72) Inventor: Daniel Deutsch, Orlando, FL (US)

(73) Assignee: Real Simple Ideas, LLC, Orlando, FL (US)

(21) Appl. No.: 17/866,617

(22) Filed: Jul. 18, 2022

Related U.S. Application Data
(60) Provisional application No. 63/223,708, filed on Jul. 20, 2021.

(51) Int. Cl. A63H 27/10

(52) U.S. Cl. CPC A63H 27/10; A63H 2027/1091; A63H 2027/1083; A63H 2027/1058

(57) ABSTRACT

An internal balloon projector includes a body insertable through a balloon opening having a power module and a projection module. The projection module receives electrical power from the power module and is operable to project an image onto an inner surface of the balloon when inserted therein. A balloon assembly includes a balloon with the projector inserted therein. The balloon is inflatable via an inflation passage formed within the body, and can be deflated and reinflated. The internal balloon projector can sequentially project multiple images on the inner surface of the balloon.

### CROSS-REFERENCE TO RELATED APPLICATION

This application claims the benefit of U.S. Provisional Patent Application Ser. No. 63/223,708, filed on Jul. 20, 2021, the contents of which are herein incorporated by reference in their entirety.

### FIELD OF THE INVENTION

The present invention relates to balloons, and more particularly, devices and methods for projecting images onto the surface of balloons.

### BACKGROUND OF THE INVENTION

Balloons have delighted young and old alike on birthdays, holidays and countless other special occasions for over a hundred years. Popularly, balloons are decorated with words and pictures to make a special statement or just to increase the visual appeal. These decorations are normally applied in connection with the making of the balloon and a customer selects from colors and decorations available at a given retailer.

Less commonly, articles are placed inside balloons—typically transparent balloons—for another fun look. For example, balloon creations filled with glitter, LED lights, stuffed animals and other even other balloons have been made. These creations can sometimes be difficult and time-consuming to make, however, and sometimes even require special equipment to fill and inflate. While there are several fun and entertaining balloon options, further improvements are possible.

### SUMMARY OF THE INVENTION

In view of the foregoing, it is an object of the present invention to provide an internal balloon projector and related methods. According to an embodiment of the present invention, an internal balloon projector includes a body insertable through a balloon opening having a power module and a projection module. The projection module receives electrical power from the power module and is operable to project an image onto an inner surface of the balloon when inserted therein. A balloon assembly includes a balloon with the projector inserted therein.

According to an aspect of the present invention, the body defines an inflation passage extending from an inlet to an outlet. With the body inserted in the balloon, the inlet remains outside the balloon and the outlet is inside the balloon. An internal check valve in the inflation passage only allows air to be introduced into the balloon therethrough. According to another aspect of the present invention, the power module and the projection module are releasably connected. According to a further aspect, the inflation passage is formed entirely within the power module.

According to a method aspect, a distal end of a body of the internal balloon projector is inserted through a neck of a balloon such that a proximal end of the body remains outside the balloon, and the internal balloon projector is operated to project an image onto an inner surface of the balloon. According to a further aspect, a plurality of images are sequentially projected onto the inner surface of the balloon from the internal balloon projector.

These and other objects, aspects and advantages of the present invention will be better appreciated in view of the drawings and following detailed description of preferred embodiments.

### BRIEF DESCRIPTION OF THE DRAWINGS

FIG. 1 is a side view of an internal balloon projector inserted into a balloon including a body having a power module and a projection module, according to an embodiment of the present invention;

FIG. 2 is a side view of the internal balloon projector of FIG. 1, with the power and projection modules separated;

FIG. 3 is a partially cut-away perspective view of the power module of FIG. 1;

FIG. 4 is a partially cut-away perspective view of the projection module of FIG. 1; and

FIG. 5 is a schematic end view of an imagery film of the projection module of FIG. 1.

### DETAILED DESCRIPTION OF PREFERRED EMBODIMENTS

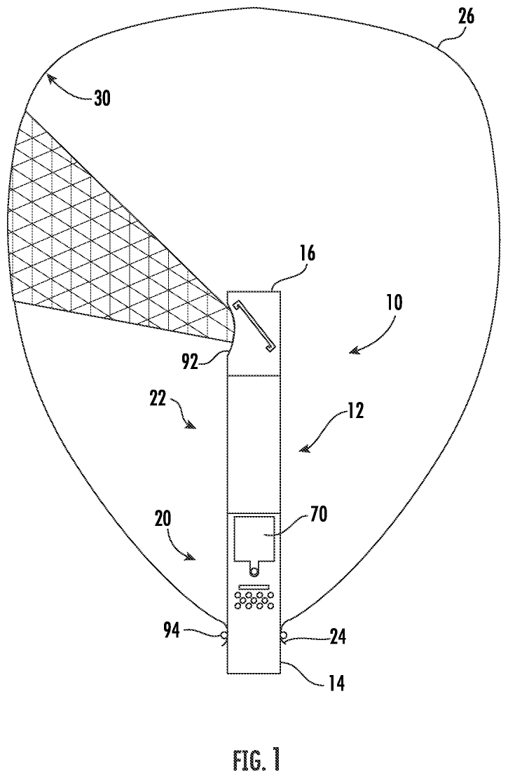

According to an embodiment of the present invention, referring to FIGS. 1 and 2, an internal balloon projector 10 has a body 12 extending between a proximal end 14 and distal end 16 and including a power module 20 and a projection module 22. In use, the distal end 16 is inserted through the neck 24 of a balloon 26 with the proximal end 14 remaining outside. The power module 20 supplies electrical power to the projection module 22, which is operable to project an image onto an inner surface 30 of the balloon. Due to the translucency of the balloon 26, the image is then visible from the outside.

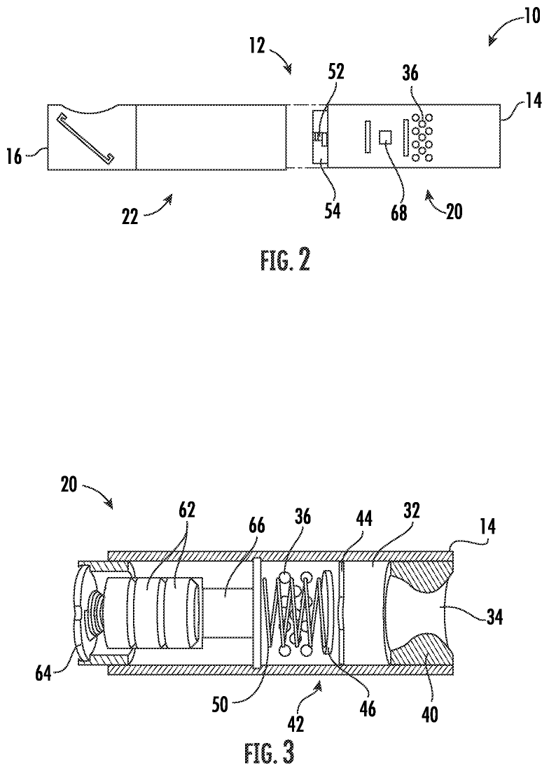

Referring also to FIG. 3, an inflation passage 32 extends through the body 12 from an inlet 34 outside the balloon 26 to an outlet 36 within the balloon 26. The inlet 34 extends inwardly from an end face of the proximal end 14 and includes a reduced diameter portion 40 to more tightly seal against standard balloon inflation nozzles. The outlet 36 is preferably formed as a plurality of outlet openings extending through a side of the body 12 inwardly of the proximal end 14.

Advantageously, a check valve 42 is located in the inflation passage 32 to prevent the flow of air back out the balloon. The check valve 42 includes an orifice plate 44 closed by a valve plate 46 biased into a closed position by a spring 50. Air pressure applied from the inlet 34 will unseat the valve plate 46, allowing air to pass through the orifice plate 44 and inflate the balloon 26 through the outlet 36.

In depicted embodiment, the inflation passage 32 is formed completely within the power module 20, which is detachable from the projection module 22. One or more locking elements 52 on a male locking collar 54 extending from an inner end of the power module 20 engage one or more complementary locking elements 56 on a female locking collar 60 of the projection module 22 to secure the modules 20, 22 together.

In addition to the inflation passage 32, the power module 20 includes one or more batteries 62 electrically connected to a contact plate 64 through a switch 66. A manual operator 68 for the switch 66 is located on the exterior of the module 20, where it can be operated before or after insertion of the body 12 into the balloon 26. Although the operator 68 will be within the balloon 26 after insertion, the flexibility of the balloon material and the proximity of the operator 68 to the neck 24 will still allow operation. The batteries 62 can be replaced via a battery cover 70 in the body 12.

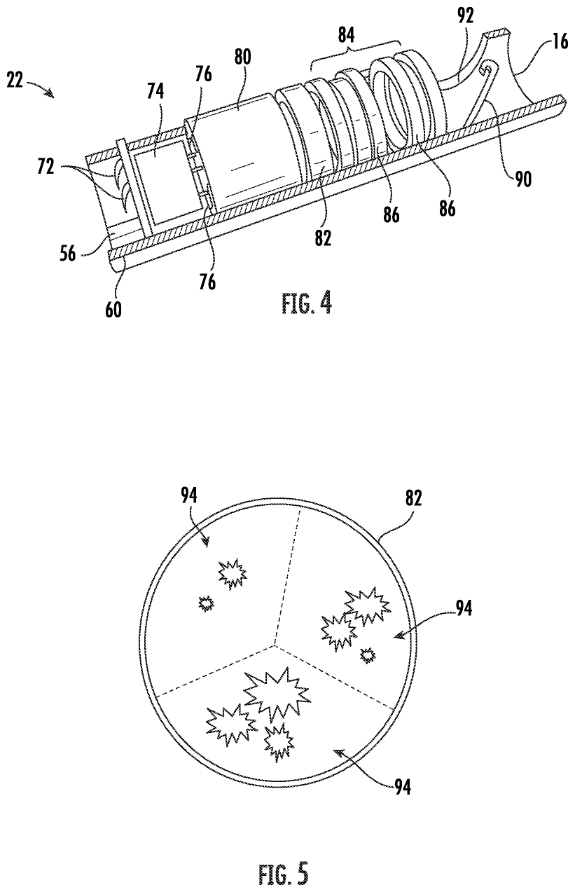

Referring to FIG. 4, the projection module includes contacts 72 for engaging the contact plate 64 and supplying it to control electronics 74 that operate one or more light emitting diodes (LEDs) 76. In a preferred embodiment, three white LEDs are used.

Light from the LEDs 76 is advantageously directed through a beam isolator tube 80, imagery film 82 and lens arrangement 84 containing one or more lenses 86. The focused image from the lens arrangement 84 is then reflected off an angled mirror 90 through a projection aperture 92 extending through a wall of the projection module 22 near the distal end 16 of the body.

Advantageously, referring to FIG. 5, multiple images 94 are formed on the imagery film 82 and the control electronics 74 are configured to sequentially turn on an off the LEDs 76 to separately highlight each of the multiple images. With the LEDs 76 being cycled rapidly in sequence through variations of a similar image, an animation effect can be generated. In the depicted embodiment, three images 84 are used corresponding to three LEDs 76; however, it will be appreciated that more or fewer images and LEDs could be used.

In use, a customer selects a balloon 26 and decides on a desired image for projection and a vendor selects a projection module 22 corresponding to the desired image. The selected projection module 22 is attached to a power module 20 and the distal end 16 of the combined body of the projector 10 is inserted into the selected balloon 26 through its neck 24. A tie, ring or other suitable closure 94 is placed around the neck 24 to secure the balloon 26 to the body 12 with the outlet 36 of the inflation passage 32 inside the balloon 26 and the proximal end 14 and inlet 34 remaining outside.

The balloon 26 is inflated through the passage 32 with helium, ambient air or other gas to an appropriate volume, with the check valve 42 and the closure 94 cooperating to maintain pressure inside the balloon. At a desired point in the process, the projector 10 is energized via the operator 68, resulting in projection of the desired image onto the inner surface 30. The customer may later opt to turn the projector 10 off and on, and also to remove the projector 10. This can be done to intentionally deflate the balloon 26 (e.g., if needed to pass through airport security or otherwise for convenience during travel) and subsequently reinflate the balloon 26 later. Additionally, the projector 10 could be used subsequently with other balloons.

It will be appreciated that a projector according to the present invention, can be used with any suitable balloon. If desired, balloons featuring pre-applied designs can also be used with the projector, including designs that complement the projected image (e.g., forming a frame around the projected image). Advantageously, the projector allows customers to pick any desired balloon upon which to project their selected images, rather than being limited to particular balloon types and colors that happen to be in stock with a desired image thereon. The use of detachable power and projection modules allows simplifies inventory management and allows a customer to potentially select multiple different projection modules for use with the same power module.

The above-described embodiments are provided for illustrative purposes; the present invention is not necessarily limited thereto. Rather, those skilled in the art will appreciate that various modifications, as well as adaptations to particular circumstances, will fall within the scope of the invention herein shown and described and of the claims appended hereto.

What is claimed is:

1. An internal balloon projector comprising:
a body extending between a proximal end and distal end, the distal end being insertable through a neck of a balloon with the proximal end remaining outside, the body including:
a projection module operable to project an image from the body onto an inner surface of the balloon; and
a power module supplying electrical power to the projection module.

2. The internal balloon projector of claim 1, wherein an inflation passage extends through the body from an inlet at the proximal end to an outlet closer to the distal end, such that, with the distal end inserted through the neck of the balloon, the inlet will remain outside the balloon and the outlet will be inside the balloon.

3. The internal balloon projector 2, wherein the inlet is located in an end face of the proximal end.

4. The internal balloon projector of claim 2, wherein a check valve is located in the inflation passage between the inlet and the outlet, the check valve being operable to allow airflow from the inlet to the outlet and block reverse airflow from the outlet to the inlet.

5. The internal balloon projector of claim 1, wherein the power module is detachable from the projection module, such that a plurality of different projection modules are usable with the power module.

6. The internal balloon projector of claim 1, wherein the power module includes at least one battery electrically connected to the power module through a switch.

7. The internal balloon projector of claim 6, wherein a manual operator for the switch is located an exterior of the body.

8. The internal balloon projector of claim 7, wherein, with the distal end inserted through the neck of the balloon, the manual operator is within the balloon and operable therethrough.

9. The internal balloon projector of claim 1, wherein the projection module includes a light source directing light through an imagery film out a projection aperture in the body.

10. The internal balloon projection of claim 9, wherein the projection module further includes a lens arrangement between the light source and the projection aperture.

11. The internal balloon projector of claim 9, wherein the light source directs the light toward the distal end of the body and the projection aperture is formed in a side of the body, the projection module further including an angled mirror reflecting the light out the projection aperture.

12. The internal balloon projector of claim 9, wherein the light source includes at least one light emitting diode (LED).

13. The internal balloon projector of claim 12, wherein the light source further includes a beam isolator tube through which the light from the at least one LED is directed.

14. The internal balloon projector of claim 12, wherein the light source includes a plurality of LEDs and the projection module further includes control electronics configured to sequentially turn the plurality of LEDs on and off.

15. The internal balloon projector of claim 14, wherein the imagery film includes a plurality of images corresponding to the plurality of LEDs such that the sequentially turning on and off of the plurality of LEDs separately highlights each of the plurality of images.

16. A balloon assembly comprising:
a balloon having a neck; and
the balloon projector of claim 1 having its distal end inserted through the neck with the proximal end remaining outside.

17. The balloon assembly of claim 16, wherein the balloon projector is projecting an image onto an inner surface of the balloon.

18. A method of using an internal balloon projector, the method comprising:
inserting a distal end of a body of the internal balloon projector through a neck of a balloon such that a proximal end of the body remains outside the balloon; and
operating the internal balloon projector to project an image onto an inner surface of the balloon.

19. The method of claim 18, further comprising inflating the balloon through an inflation passage in the body after inserting the distal end through the neck of the balloon.

20. The method of claim 19, further comprising subsequently deflating the balloon and then reinflating the balloon through the inflation passage.

21. The method of claim 18, further comprising selecting a projection module on the internal balloon projector that is configured to project a desired image and connecting the projection module to a power module before inserting the distal end through the neck of the balloon.

22. The method of claim 18, further comprising sequentially projecting a plurality of images onto the inner surface of the balloon from the internal balloon projector.

23. The method of claim 22, wherein sequentially projecting the plurality of images includes sequentially turning on and off a plurality of light emitting diodes (LEDs) to separately highlight the plurality of images on imagery film within the internal balloon projector.
